(19) United States
(12) Patent Application Publication
(10) Pub. No.: US 2005/0136157 A1
(43) Pub. Date: Jun. 23, 2005

(54) Wheaten food with powdery soup in a cupped container and method of eating the same

(76) Inventor: Masayo Ebihara, Aichi (JP)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/877,375

(22) Filed: Jun. 25, 2004

(30) Foreign Application Priority Data
Dec. 22, 2003 (JP) 2003-425316

(51) Int. Cl. A23B 4/00

(52) U.S. Cl. 426/120

(57) ABSTRACT

A wheaten food with powdery soup in a cupped container, comprising an outer container for containing a powdery soup-containing pouch, and an inner container housed in the outer container attached with an inner lid for containing a bread and attached with a plurality of small aperture, the inner container being contained in the outer container and sealed with an outer lid before use. The wheaten food is eaten by the method of detaching the outer lid and taking out the inner container, seal-opening the powdery soup-containing pouch and placing the powdery soup in the outer container, pouring hot water to make a soup, capping the inner container being up-turned over the outer container, and causing steams evolved upon soup making to flow through the smaller apertures to the inside of the inner container thereby moistening and warming the bread. Then, the inner lid is opened to take out the bread, which can be eaten while soaking in the soup.

### BACKGROUND OF THE INVENTION

1. Field of the Invention

The present invention concerns a wheaten food with powdery soup in a cupped container and a method of eating the same suitable to consumption of wheaten foods, for example, breads while soaking them in soups.

2. Description of the Related Art

Instant noodles represented by foods contained in cupped containers are served by pouring a necessary amount of hot water to dehydrated noodles contained in a cupped container, waiting for several minutes and then taking them at the instance the noodles are disintegrated and swollen. Further, in a case of instant noodles in which powdery soups or ingredients are sealed in pouches, powdery soups and ingredients are taken out of the pouches into the containers, and dissolved them by pouring hot water, and they are eaten together with disintegrated and swollen noodles (for example, refer to JP-A No. 10-211958).

Another instant foods in a cupped container is disclosed, for example, in JP-A No. 10-00173. The instant food in the cupped container disclosed in this patent literature has a container comprising a lower part of a smaller diameter and an upper part of a larger diameter, and a lid fitted to the upper end of the container to form a cupped container, in which a food which is melted upon heating is placed in the lower smaller diameter part and a solid state food is placed in a larger diameter upper part while being hooked at an intermediate position of the container. Since the food to be melted upon heating and the solid state food are kept separated immediately before they are consumed, they are not mixed during storage to deteriorate the taste. Upon eating, the food placed in the lower part is melted by heating and the solid state food placed in the upper part is disintegrated and mixed to the molten food and served for eating.

The food in the lower part which is melted upon heating can include, for example, soup, miso-soup, meat source, sweet bean paste, and curry roux cooked to such a hardness as not spilling even when tilted by the incorporation of an appropriate amount of gelatin, starch, wheat flour, or powdery curry, or frozen foods thereof, or frozen food of tea. The food in the solid state in the upper part can include, for example, rice ball, roast rice ball, not-heated rice ball incorporated with gelatin material, slightly roasted rice ball incorporated with gelatin material, rice cake, bread, or buckwheat noodle, Japanese wheat noodle, and spaghetti frozen to a solid state before heating. By the combination of foods in the upper and lower parts, they can be served, for example, as rice with soup, rice gluer, rice with curry soup, boiled rice with tea, meat sauce spaghetti, soup spaghetti and sweet bean sauce with rice cake.

In JP-A No. 10-001173, when a bread and a soup are combined as foods in the upper and lower parts, a bread with soup can be served. After heating the food in the cupped container by an electronic oven or the like to melt the soup, the bread in the upper part is disintegrated and dropped into the soup in the lower part and eaten. In this case, depending on the proportion of the amount of the soup and the bread, when the bread is disintegrated and dropped into the soup, since bread pieces are wetted with the soup into a swollen state, the bread with soup can not be eaten in a preferred state of incorporating an appropriate amount of the soup to the bread pieces. Further, when the soup is heated to melt, since the bread is also heated, water contained in the bread is released to form a dehydrated state and lose the delicious taste inherent to the bread.

On the other hand, by providing a soup and a bread separately and eating the bread while plucking the bread and soaking pieces thereof into the soup, the bread with soup can be consumed in a preferred state of incorporating an appropriate amount of the soup to the bread pieces. However, such bread with soup can not be served in a case where a bread is not available at hand or a soup is not available at hand even if the bread is available.

The present invention has been accomplished in view of the problems in the prior art and it particularly intends to provide a wheaten food with powdery soup in a cupped container capable of eating the bread with soup without losing the delicious taste inherent to the bread and also capable of being applicable to other wheaten foods than the bread, as well as a method of eating the same.

### SUMMARY OF THE INVENTION

The foregoing object can be attained by a wheaten food with powdery soup in a cupped container according to the present invention, comprising an outer container, an inner container housed in the outer container, a wheaten food contained in the inner container, a powdery soup-containing pouch contained in the outer container, an inner lid having a plurality of small apertures for covering the inner container and an outer lid for sealing the outer container.

The present invention provides, in another feature, a wheaten food with powdery soup in a cupped container in which a cupped container is partitioned at the inside thereof by uprightly installing a partitioning wall of a size somewhat lower than the depth of the cupped container inside of the cupped container, a wheaten food is contained in one of compartments, and a powdery soup-containing pouch is contained in the other of the compartments, and a lid is appended to the upper end opening of the cupped container.

In a preferred embodiment of the wheaten food with soup in a cupped container, a water absorption layer comprising a water absorption material is disposed at the inner surface of the lid situating at least said one of the compartments for containing the wheaten food.

The present invention provides in a further feature, a wheaten food with powdery soup in a cupped container, in which a cupped container is partitioned at the inside thereof by uprightly installing a partitioning wall of a size identical with the depth of the cupped container inside of the cupped container, a steam permeation layer comprising a material not permeating water droplets but permeating steams is disposed to the upper end of the partitioning wall, a wheaten food is contained in one of the compartments, a powdery soup-containing pouch is contained in the other of the compartments, and a lid is appended to the upper end opening of the cupped container.

The present invention provides in a still further feature, a wheaten food with powdery soup in the cupped container, in which a bread and a powdery soup-containing pouch are contained in the cupped container and a lid is pasted to the upper end opening of the cupped container.

In a preferred embodiment of the wheaten food with powdery soup in the cupped container according to the invention, the wheaten food is a bread.

The bread is preferably dehydrated or semi-dehydrated bread prepared such that the water content therein is somewhat reduced.

The wheaten food with powdery soup in a cupped container described above according to the invention is eaten by a method according to the invention, comprising opening an outer lid to take-out an inner container, seal opening the powdery soup-containing pouch, entering a powdery soup to the inside of the outer container, pouring a required amount of hot water to dissolve the powdery soup, capping immediately thereafter the inner container to the opening end of the outer container such that an inner lid is situated below, leaving them for a predetermined period of time thereby causing steams evolved upon dissolving the powdery soup to flow into the inner container by way of a plurality of small apertures thereby moistening and warming the wheaten food, then opening the inner lid of the inner container to take out the wheaten food, and eating the same while soaking the food into the powdery soup in the outer container.

The wheaten food with powdery soup in a cupped container in another feature of the invention is eaten by a method according to the invention comprising, peeling a portion of the lid, seal opening the powdery soup-containing pouch thereby entering the powdery soup into the other of the compartments, pouring a required amount of hot water to dissolve the powdery soup, capping the lid immediately thereafter to seal the upper end opening of the cupped container, causing the steams evolved upon dissolving the powdery soup to enter from the space above the partitioning wall or from the upper end of the partitioning wall into one of the compartments thereby moistening and warming the wheaten food, then entirely peeling the lid of the cupped container and taking out the wheaten food, and eating the same while soaking the food in the powdery soup in the other of the compartments.

According to the first feature of the present invention, since the cupped container comprises the outer container and the inner container separable from the outer container and the wheaten food is contained in the inner container, the wheaten food in the inner container can be moistened and warmed by causing the steams evolved, upon pouring hot water and making the powdery soup, into the outer container, to flow through the plurality of smaller apertures formed in the inner lid. Thus, oven heating or the like is no more necessary and this can prevent the worry that the water content in the wheaten food is released during heating to dehydrate the food and loss the delicious taste inherent to the wheaten food.

According to another feature of the invention, since the cupped container is partitioned at the inside thereof by vertically disposing the partitioning wall, this can prevent that the water content in the wheaten food is released to dehydrate the food by the heat upon making powdery soup, and the wheaten food can be moistened and warmed by the entering of the steams evolved, upon powdery soup making, from the space above the partitioning wall into the compartment containing the wheaten food.

In a preferred embodiment for the another feature, since the water absorbing layer comprising the water absorbing material is disposed to the inner surface of the lid situating at least above one of the compartments for containing the wheaten food, steams evolved upon powdery soup making, flow into the compartment containing the wheaten food, and condensed water which is cooled and condensed at the inner surface of the lid of the compartment is absorbed. Without the water absorbing layer, the water droplets condensed at the inner surface of the lid would possibly drop to wet the wheaten food with water. However, such water wetting can be prevented by this embodiment.

In accordance with a further feature of the invention, since the inside of the cupped container is partitioned by vertically locating the partitioning wall of the size identical with the depth of the cupped container inside of the cupped container, and the steam permeation layer comprising the material not permeating water droplets but permeating steams is disposed to the upper end of the partitioning wall, when a portion of the steams evolved, upon powdery soup making, is cooled at the inner surface of the lid and present in admixture as water droplets of large particles, they are shielded by the steam permeation layer. Thus, steams at a low water content flow to the compartment containing the wheaten food thereby capable of preventing excess moistening of the wheaten food.

In accordance with a still further feature of the invention, since the bread and powdery soup-containing pouch are contained in combination in the cupped container, a bread with soup can be eaten easily. Accordingly, it is no more necessary to always provide bread and soup together at hand.

In a preferred embodiment of the invention, since the wheaten food is a bread, a soft bread can be prepared by moistening and warming the bread by the steams evolved upon soup making.

In a preferred embodiment of the invention, since the bread is dehydrated or semi-dehydrated bread prepared such that the water content therein is somewhat reduced, the bread can be conditioned so as not to be extremely moistened when moistening and warming the bread by the steams evolved upon soup making. This can serve a delicious bread in a state as if it were freshly baked.

In the first feature of the invention for the method of eating the wheaten food with powdery soup in a cupped container, an inner container containing a wheaten food is placed so as to cap the opening of an outer container with the inner lid being upturned, upon making a soup by pouring hot water in the outer container, thereby causing steams evolved in the outer container to flow into the inner container by way of a plurality of small apertures formed in the inner lid, thereby capable of moistening and warming the wheaten food. Thus, the wheaten food with soup can be eaten with delicious taste. In a case where the wheaten food is a bread, a bread in a state as if they are almost freshly baked can be eaten while soaking the same in the soup.

In the invention another method of eating the wheaten food with powdery soup in a cupped container in other feature of the invention, steams evolved upon soup making can be caused to flow by utilizing an upper space between the lid and the partitioning wall of the upper end portion or the partitioning wall into the compartment containing the wheaten food to moisten and warm the wheaten food. Thus, the wheaten food with soup can be eaten with a delicious taste. In a case where the wheaten is a bread, a bread in a state if it were freshly baked can be eaten while soaking the soup.

### BRIEF DESCRIPTION OF THE DRAWINGS

The present invention is to be described with reference to preferred embodiments showing the accompanying drawings.

FIG. 1 is a schematic cross sectional view showing a first embodiment of applying the present invention to a bread;

FIG. 2 is a schematic perspective view of an inner container in FIG. 1;

FIG. 3 is a schematic cross sectional view showing a state of moistening and warming a bread by steams immediately after making soup;

FIG. 4 is a schematic cross sectional view showing a second embodiment of applying the present invention to the bread;

FIG. 5 is a schematic upper plan view of the cupped container;

FIG. 6 is a schematic cross sectional view showing a state of preparing a soup.

FIG. 7 is a schematic cross sectional view showing a third embodiment of applying the invention to a bread;

FIG. 8 is a schematic cross sectional view showing a fourth embodiment of applying the invention to a bread, and

FIG. 9 is a schematic cross sectional view showing a fifth embodiment of applying the invention to a bread.

### DESCRIPTION OF THE PREFERRED EMBODIMENTS

A wheaten product with powdery soup in a cupped container, as well as a method of eating the food are to be described by way of preferred embodiments with reference to the accompanying drawings.

### EXAMPLE 1

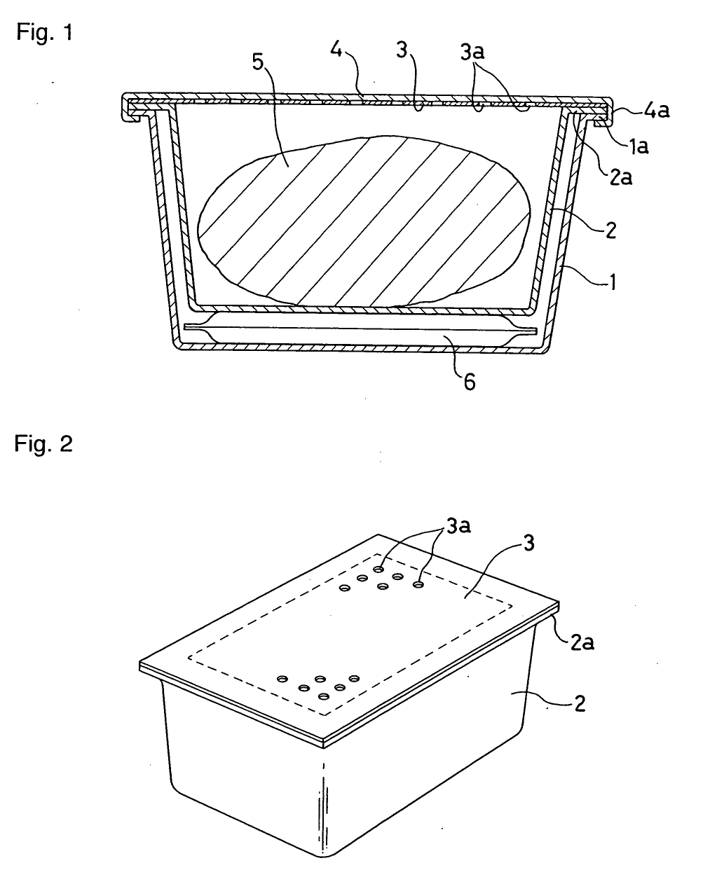

FIG. 1 is a schematic cross sectional view showing a first embodiment of applying the present invention to a bread.

FIG. 2 is a schematic perspective view of an inner container in FIG. 1.

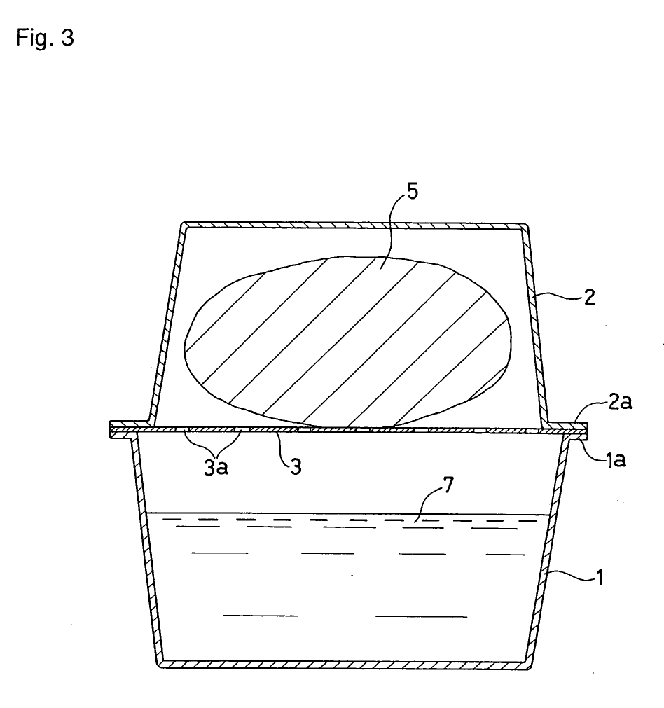

FIG. 3 is a schematic cross sectional view showing a state of moistening and warming a bread by steams immediately after preparing a soup.

In FIG. 1, an outer container 1 is formed, for example, of a resin, or by coating a resin or appending a resin film on the surface of paper as a substrate. The resin is preferably heat resistant. While the outer container 1 is formed into a square shape having a predetermined size, it may be formed to other shape such as a circular or elliptic shape. The container is opened at the top and has a horizontal edge 1a formed at the opening end thereof.

An inner container 2 is formed, like the outer container 1, for example, of a resin, or by coating a resin or appending a resin film on the surface of paper as a substrate. The resin may not necessary be heat resistant. While the inner container 2 is formed into a square shape smaller than that of the outer container 1, it may be formed to other shape such as a circular or elliptic shape. The container is opened at the top end and has a horizontal edge 2a formed at the opening end thereof like the outer container 1. Further, a thin inner lid 3 made of a resin or made of paper appended with a resin film is attached to the opening end of the inner container 2 being appended at the edge 2a. A plurality of smaller apertures 3a are formed substantially over the entire area of the inner lid 3 as shown in FIG. 2. The inner lid 3 is preferably heat resistant.

An outer lid 4 made of a resin or paper appended with a resin film has an engaging part 4a along the outer circumferential edge. The outer lid 4 can seal the inner container 2 and the outer container 1 together by placing the inner container 2 down into the outer container 1 such that the edge 2a of the inner container 2 is received on the edge 1a of the outer container 1, and sandwiching and engaging the joined portion between the edge 1a of the outer container 1 and the edge 2a of the inner container 2 by the engaging part 4a while capping the lid thereover. Further, although not illustrated, they may also be covered entirely with a transparent moisture proof heat shrinkable film or sheet to improve the sealability.

A bread 5 is contained in the container 2. While the size and the shape are not always limited, it is smaller in the size than the inner volume of the container 2 so as to provide a gap in the inner container 2. The bread 5 may be a bread baked by a customary making method and, it is particularly, a bread fermented by utilizing a panettone yeast which can extend the storage period. Depending on the state of preservation, the storage period of the panettone yeast fermented bread has a long shelf life sufficiently while the storage period for usual breads at normal temperature for about 3 days. In this case, since the bread 5 is contained in the inner vessel 2 and light causing oxidation of the bread can be sealed, it can be reserved advantageously for a long period of time.

Further, when the bread utilizing the panettone yeast is formed into a breadstick such as Grissini and baked at a lower temperature (about 160° C.) for longer time (about 25 min) than usual, it is possible to prepare dehydrated bread or semi-dehydrated bread controlled to lower water content than usual bread, and the keeping quality can be more improved. Further, when a biscuit dough incorporated with food fibers are placed on the surface of the bread utilizing the panettone yeast, formed flat and then baked, a bread of good storage stability and served as health food can be prepared. Further, when a flour paste is incorporated in the bread, various seasonings are possible. In addition, since breads are usually incorporated with a great amount of water and less auxiliary materials, the total energy is derived from wheat flour. However, the total energy is increased more than that in usual breads by using egg, processed oils and fats in a greater amount.

A powdery soup-containing pouch 6 is contained in the outer container 1 and an appropriate amount of a powdery soup is sealed in the moisture proof pouch. When hot water is poured to dissolve the powdery soup, a soup can be prepared as the soup. Various soups such as corn soup, clear soup (consommé) can be selected and used. The soup is not restricted only to the powder but may be a condensed liquid. Depending on the kind of the bread, those other than the soup, for example, coffee, milk or tea may also be used. In this case, instant powdery coffee or powdery milk may be packed in a pouch, and tea may be packed in a filter paper pouch.

A method of eating the wheaten food with powdery soup in the cupped container constituted as described above (bread in this embodiment) is to be described. In the cupped container, the outer lid 4 is at first detached. In a case where the entire portion is covered with a heat shrinkable film or sheet, it will be apparent that the cover is broken and removed, and then the outer lid 4 is detached. Then, the inner container 2 with the inner lid 3 is taken out of the outer container 1 for making the soup.

In making the soup, the powdery soup-containing pouch 6 is taken out from the bottom inside the outer container 1 and seal-opened. Then, the powdery soup is placed in the outer container 1 and a previously provided hot water is poured while stirring with a spoon or the like to dissolve the powdery soup by pouring the hot water in a predetermined amount. Thus, the soup 7 is prepared in the outer vessel 1.

Immediately after the preparation of the soup 7, the inner container 2 is downwarded and cap the outer container 1 as shown in FIG. 3. In this case, when the outer circumferential edge at the lower end of the inner container 2 and the outer circumferential edge at the upper end of the outer container 1 are mated, the edge 2a of the inner container 2 is received on the edge 1a of the outer container 1. Thus, the inner container 2 is held by the outer container 1 stably and in a closely bonded state.

In this state, the bread 5 contained in the inner container 2 is not dropped into the soup 7 in the outer container 1 since the bread is received by the inner lid 3. Further, since a plurality of small apertures 3a are formed in the inner lid 3, steams generated upon preparation of the soup flow through the smaller apertures 3a into the inner container 2 to moisten and warm the bread 5. Since the gap is present between the inner container 2 and the bread 5, a sufficient amount of steams flow through the small apertures 3a and the entered steams conduct convection in the inner container 2. When moistening and warming by the steams are conducted for several minutes (usually 5 to 6 minutes while different depending on the kind of the bread), the bread 5 swells into a soft state and warmed properly into a state as if it were baked freshly. Particularly, in a case of dehydrated or semi-dehydrated bread, moistening and warming by the steams act effectively to in views delicious taste inherent to the bread.

Then, when the inner container 2 is detached and the inner lid 3 is opened, the bread 5 can be taken out. Then, the bread 5 can be eaten while plucking it little by little and soaking the same in the soup 7 in the outer vessel 1. During moistening and warming of the bread 5, since the inside of the outer container 1 is tightly closed by the inner container 2, the soup 7 can be kept warm and rapid cooling is inhibited. Thus, the warmed bread 5 can be eaten with delicious taste while soaking it in the warm soup 7.

### Example 2

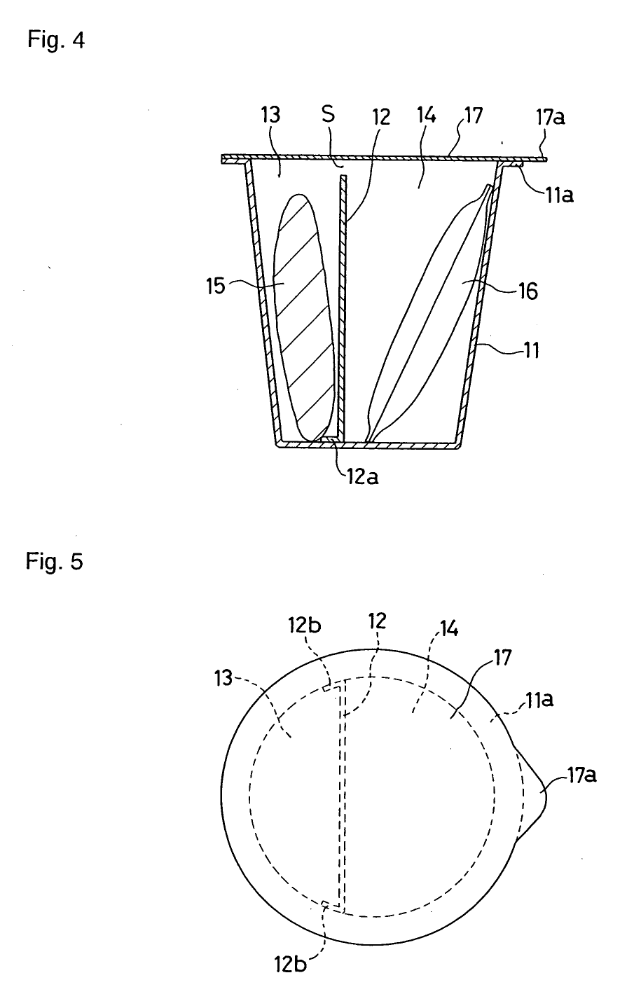

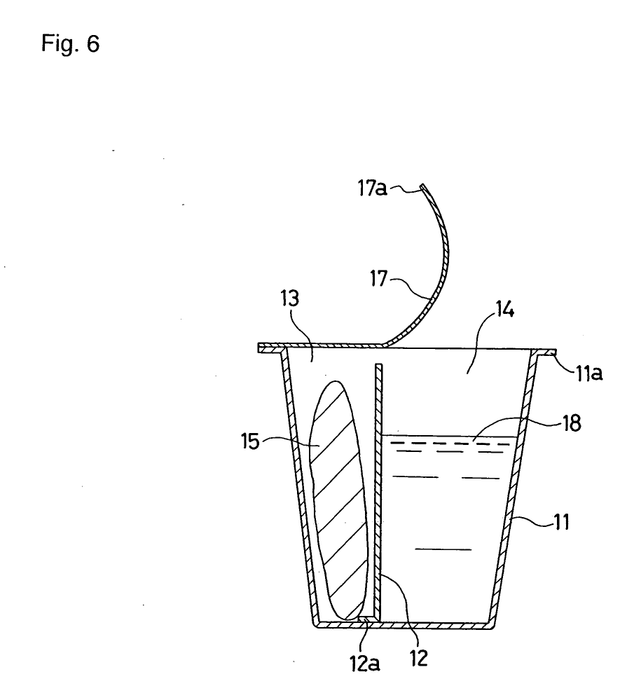

FIG. 4 to FIG. 6 show another embodiment of the wheaten food with powdery soup in cupped container and the method of eating the same according to the present invention. FIG. 4 is an schematic cross sectional view showing a second embodiment of applying the invention to a bread, FIG. 5 is a schematic upper plan view of a cupped container, and FIG. 6 is a schematic cross sectional view showing a state of preparing a soup.

In FIG. 4, an outer container 11 is formed, for example, of a resin, or by coating a resin or appending a resin film on the surface of paper as a substrate. The resin is preferably heat resistant. While the cupped container 11 is formed into a circular shape having a predetermined size, it may be formed to other shape such as a square shape. The container is opened above and has a horizontal edge 11a formed at the opening end thereof.

The cupped container 11 is partitioned at the inside by vertically disposing a partitioning wall 12. The partitioning wall 12 is attached by bonding the bent piece 12a at the lower end to the inner bottom surface of the cupped container 11 and bent pieces 12b on both side ends to the inner wall surface of the cupped container 11 respectively as shown in FIG. 5. In this case, the partitioning wall 12 is disposed vertically at a position slightly displaced sideway of the center of the cupped container 11 and is set to a size slightly lower by 5 mm to 10 mm than the depth of the cupped container 11.

In the compartments divided by the partitioning wall 12, a bread 15 is contained in a first narrow compartment 13 while a powdery soup-containing pouch 16 is contained in a large second compartment 14. Then, by appending a lid 17 to the upper end opening of the cupped container 11, the cupped container 11 is sealed. Further, the number of the compartments in the cupped container 11 divided by the partitioning wall 12 is not restricted to two. For example, although not illustrated, it may be possible to partition the cupped container into three compartments and different kinds of breads or different kinds of powdery soup-containing pouch can be contained in the two compartments thereof.

The lid 17 is formed thinly, for example, with a resin or by coating a resin or appending a resin film on the surface of paper as a substrate. The outer circumferential edge of the lid 17 is attached to the edge 11a of the cupped container 11 by bonding, and a pick-up lug 17a protruding sideway is disposed to a portion of the outer circumferential edge as shown in FIG. 5. The lug 17a is positioned on the side of the second compartment 14.

The size and the shape of the bread 15 contained in the first compartment 13 are not always restricted and it is made smaller than the inner volume of the first compartment 13 so as to provide a gap in the first compartment 13. The bread 15 are a bread baked by a usual preparation method as described above and, particularly, a bread fermented by utilizing the panettone yeast can extend the storage period. In this case, since the bread 15 is contained in the cupped container 11, the light causing oxidation of the bread can be shielded and it can be reserved advantageously for a long period of time.

Further, when the bread utilizing the panettone yeast is formed into a rod-like shape and baked at a lower temperature (about 160° C.) for longer time (about 25 min) than usual, to prepare dehydrated bread or semi-dehydrated bread controlled to lower water content than usual breads, the storage stability can be improved further. It is also possible to constitute so that plural number of breads formed into rod-like shape may be contained. Further, when a biscuit dough incorporated with food fibers are placed on the surface of the bread utilizing the panettone yeast, formed flat and baked, a bread of good storage stability and served as a health food can be prepared. Further, when a flour paste is incorporated in the bread 15, various seasonings are possible. In addition, since breads are usually incorporated with a great amount of water and less auxiliary materials, the total energy is derived from wheat flour. However, the total energy is increased more than that in usual breads by using egg, process oils and fats in a greater amount.

In the powdery soup-containing pouch 16 contained in the second compartment 14, an appropriate amount of a powdery soup is contained in a moisture proof pouch in a sealed state. When the powdery soup is dissolved by pouring hot water, a soup is prepared. Various soups such as corn soup, clear soup (consommé) can be selected and used. The soup is not restricted only to the powder but may be a condensed liquid. Depending on the kind of the bread, those other than the soup, for example, coffee, milk or tea may also be used. In this case, instant powdery coffee or powdery milk may be packed in a pouch, or tea may be packed in a filter paper pouch.

The method of eating the wheaten food (bread) with powdery soup in a cupped container having a constitution as described above is to be described. At first, the lid 17 for the cupped container 11 is opened till a portion of the partitioning wall 12, that is, by a portion of an area corresponding to the second compartment 14. In this case, the lid 17 can be opened easily by raising the lug 17a picking by fingers. In a case where the cupped container 11 is entirely covered with a heat shrinkable film or sheet, although not illustrated, it will be apparent that the lid 17 is opened after breaking to remove the cover. Then, the powdery soup-containing pouch 16 is taken out from the inside of the second compartment 14 to prepare a soup.

In the soup preparation, the powdery soup-containing pouch 16 is seal-opened, the powdery soup is placed in the second compartment 14 and a previously prepared warmed water (usually hot water) is poured while stirring by a spoon or the like, and the powdery soup is dissolved sufficiently by pouring hot water in a predetermined amount. Thus, a soup 18 is prepared in the second compartment 14 as shown in FIG. 6.

Immediately after the preparation of the soup, the half-opened lid 17 is put over the cupped container 11 and closed tightly by placing an appropriate weight. As the weight, for example, such as a kettle or a small pan used upon preparation of the soup can used. When the lid 17 is closed tightly, since a gap S is present between it and the partitioning wall 12 (refer to FIG. 4), steams evolved upon making soup passes through the gap S, flow into the first compartment 13 and moisten and warm the bread 15. Since the gap is present between the inner wall and the bread 15 in the first compartment 13, a sufficient amount of steams flows to the inside and the entering steams conduct convection in the first compartment 13. When moistening and warming by the steams are taken place for several minutes (usually 5 to 6 min while depending on the kinds of the bread), the bread 15 is swollen in a soft state and warmed properly into a state like baked freshly. Particularly, in a case of the dehydrated or semi-dehydrated bread, moistening and warming by steams act effectively to provide delicious taste inherent to the bread.

Then, the bread 15 can be taken out from the inside of the first compartment 13 by fully opening the lid 17. Then, the bread 15 can be eaten while being soaked in the soup 18 in the second compartment 14. During moistening and warming for the bread 15, since the inside of the cupped container 11 is tightly closed by the lid 17, the soup 18 is kept warm to prevent rapid cooling. Thus, the soft bread 15 as if in a freshly baked state can be eaten with a delicious taste by being soaked in the soup 18.

### Example 3

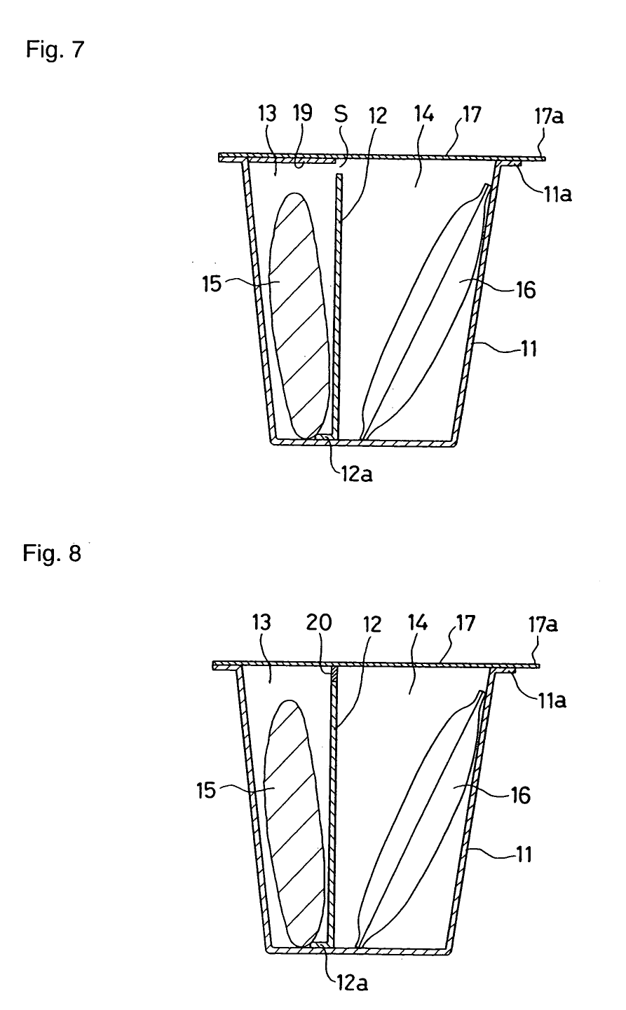

FIG. 7 is a schematic cross sectional view showing a third embodiment of applying the invention to a bread. Since most of basic constituent members are identical with those of the second embodiment, the identical constituent members with those of the second embodiment carry the same reference numerals as those in the second embodiment and their detailed descriptions are omitted.

The third embodiment has a constitution different from that of the second embodiment in that a water absorbing layer 19 comprising a water absorbing material is disposed to a portion on the inner surface of the lid 17. That is, the water absorbing layer 19 is disposed to a portion at the inner surface of the lid 17 situating just above the first compartment 13. As the water absorbing layer 19, for example, a water absorbing material comprising a natural material such as absorbent cotton, sponge or pulp can be used and use of a superabsorbent polymer of excellent water absorbability is preferred.

The superabsorbent polymer is processed, for example, by graft polymerizing an acrylic monomer to starch. The water soluble polymer is partially crosslinked and insolubilized basically in the production process. The cross linking can prevent dissolution in water and store a great amount of water between molecules. Then, the superabsorbent polymer has a water absorbing power several hundred times as high as the own weight and has water retention of not detaching water under a slight pressure. At present, various kinds of superabsorbent polymer have been developed and they are generally classified into starch-acrylic acid system such as natural polymers, acrylic acids system, carboxyl methyl cellulose series, etc. as synthesis chemical products. The water absorbing layer 19 may be disposed not only above the first compartment 13 but also above the second compartment 14.

When the water absorbing layer 19 is disposed being positioned at least above the first compartment 13, steams evolved upon making soup in the second compartment 14, passes through the gap S and flow into the first compartment 13 to moisten and warm the bread 15 in which the layer can absorb the condensed water formed inside the lid 17 in the first compartment 13 and passing through the gap S. Without the water absorbing layer 19, since the inside of the first compartment 13 is supersaturated by the steams entering from the second compartment 14 and the outer portion of the lid 17 is at a lower temperature than the inner portion, a portion of the steams is cooled and deposits to the inside of the cooled lid 17 as condensed water. When the condensed water drops as water droplets, they wet the bread 15 and, particularly, moisten the upper half of the bread 15 excessively. Further, when the dropped water droplets are accumulated at the bottom of the first compartment 13, the lower part of the bread 15 becomes excessively moistened. When the bread 15 is moistened excessively, a portion is swollen and becomes bad taste. The water absorbing layer 19 can previously prevent such disadvantage.

Although not illustrated, in a case where the water absorbing layer is disposed also to the portion at the inner surface of the lid 17 situated above the second compartment 14, it can absorb the water droplets formed by condensation of a portion of steams evolved upon soup making by being chilled on the inner surface of the lid 17. Accordingly, the steam content in the second compartment 14 is lowered, and steams at a reduced water content flow through the gap S into the first compartment 13. As a result, the amount of condensed water formed in the first compartment 13 can be moderated. Further, since the condensed water formed in the second compartment 14 is absorbed by the water absorbing layer, neither the condensed water deposits to the inner surface of the lid 17 nor the condensed water drops into the soup.

Since the method of eating the wheaten food (bread) with powdery soup in a cupped container of the third embodiment having the constitution described above is identical with that of the second embodiment, the descriptions therefore will be omitted.

### Example 4

FIG. 8 is a schematic cross sectional view showing a fourth embodiment of applying the invention to a bread. Since most of the basic constituent members are identical with those for the second embodiment, identical constituent members with those for the second embodiment carry the same reference numerals as those for the second embodiment and their detailed descriptions will be omitted.

The forth embodiment has a constitution different from the second embodiment in that a partitioning wall 12 of the size identical with the depth of the cupped container 11 is disposed vertically, and a steam permeation layer 20 comprising a material not permeating water droplets but permeating steams is disposed to the upper end portion of the partitioning wall 12. The steam permeation layer 20 is made, for example, of a gas permeation film, a porous film and a porous non-woven fabric. A material permeating steam particles but not permeating water particles greater than them can be used for each of them.

As describe above, when the steam permeation layer 20 is disposed at the upper end of the partitioning wall 12, steams evolved upon making soup in the second compartment 14 pass through the steam permeation layer 20 into the first compartment 13 to moisten and warm the bread 15 in which water particles of large particle size formed partially in the steams can be interrupted by the steam permeation layer 20. Accordingly, the water content of steams flowing into the first compartment 13 is lowered, and the amount of condensed water formed in the first compartment 13 can be moderated. As a result, it is possible to condition the moistening for the bread 15 and prevent excessive moistening by the steams, and soft delicious bread can be prepared by the appropriate moistening and warming.

Since the method of eating the wheaten food (bread) with powdery soup in a cupped contained according to the fourth embodiment constituted as described above is also identical with that for the second embodiment and the third embodiment, description therefore will be omitted.

### Example 5

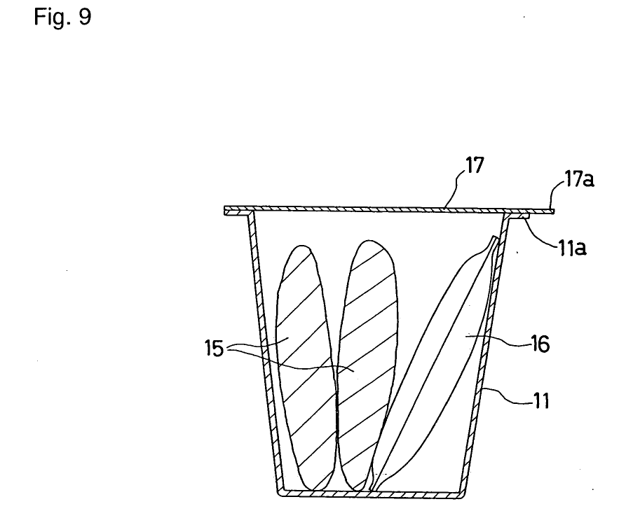

FIG. 9 is a schematic cross sectional view showing a fifth embodiment of applying the present invention to a bread. Also in this case, the constituent members identical with those for the second embodiment carry the same reference numerals as those for the second embodiment and their detailed descriptions are to be omitted.

The fifth embodiment has a constitution the second embodiment in that the partitioning wall 12 is not disposed in the cupped container 11 but a bread 15 and a powdery soup-containing pouch 16 are contained. Since the partitioning wall 12 is not present, the amount of the bread 15 contained can be increased even in the cupped container 11 of an identical volume and increase in the amount of the powdery soup-containing pouch 16 is also possible correspondingly.

In the method of eating the wheaten food (bread) with powdery soup in the cupped container according to the fifth embodiment having thus being constituted, the lid 17 is fully opened, the bread 15 and the powdery soup-containing pouch 16 are taken out, and the soup is prepared at first. In the soup making, powdery soup-containing pouch 16 is seal-opened, a powdery soup is placed in the container 11, previously provided hot water is poured while stirring with a spoon or the like, and the powdery soup is dissolved sufficiently by pouring a predetermined amount of the hot water. This can prepare the soup in the cupped container 11 although not illustrated.

In this case, it is not possible to moisten and warm the bread 15 by the steam evolved upon soup making in principle, but this it not quite impossible. For example, although not illustrated, a pair of chopsticks is bridged over the opening end of the cupped container 11 with an appropriate interval therebetween just after soup making, and a bread 15 is placed on the pair of chopsticks at an orthogonal direction. Then, the bread 15 can be moistened and warmed to some extent by steams rising from the soup. Accordingly, the bread 15 is preferably flatbread.

Alternatively, the bread 15 may be formed into a circular or elliptic shape and the circular or elliptic shape bread (not illustrated) is placed to the opening end of the cupped container 11 so as to substantially cover the same just after the soup making. Then, the bread 15 can be moistened and warmed by the steams rising from the soup. Accordingly the outer diameter of the circular or elliptic bread is preferably made somewhat larger than the inner diameter of the opening end of the cupped container 11. In a case where the outer diameter of the circular or elliptic shape bread is somewhat smaller than the inner diameter at the open end of the cupped container 11 and can not be placed, it may be placed downward somewhat from the opening end of the cupped container 11. Then, since the bread is received by the inner wall of the cupped container 11, it can be moistened and warmed by the steams. However, it is necessary that the bread 15 is not in contact with the soup.

As described above, while it has not yet been present such a food as containing the bread 15 and the powdery soup-containing pouch 16 in combination in the cupped container 11 as described above, and it is impossible to eat the bread being soaked in the soup in a case where a bread or a soup is not available at hand. However, the food according to this embodiment can easily overcome such inconvenience.

While the invention has been explained to an example of bread with powdery soup in each of the embodiments described above, the present invention is applicable also to other wheaten foods than bread, for example, buckwheat noodles or Japanese wheat noodles with noodle soup and spaghetti or macaroni with sauce.

1. A wheaten food with powdery soup in a cupped container, comprising an outer container, an inner container housed in the outer container, a wheaten food contained in the inner container, a powdery soup-containing pouch contained in the outer container, an inner lid having a plurality of small apertures for covering the inner container and an outer lid for sealing the outer container.

2. A wheaten food with powdery soup in a cupped container, in which a cupped container is partitioned at the inside thereof by uprightly installing a partitioning wall of a size somewhat lower than the depth of the cupped container inside of the cupped container, a wheaten food is contained in one of compartments, and a powdery soup-containing pouch is contained in the other of the compartments, and a lid is pasted to the upper end opening of the cupped container.

3. A wheaten food with powdery soup in a cupped container according to claim 2, wherein a water absorption layer comprising a water absorption material is disposed at the inner surface of the lid situating at least said one of the compartments for containing the wheaten food.

4. A wheaten food with powdery soup in a cupped container, in which a cupped container is partitioned at the inside thereof by uprightly installing a partitioning wall of a size identical with the depth of the cupped container inside of the cupped container, a steam permeation layer comprising a material not permeating water droplets but permeating steams is disposed to the upper end of the partitioning wall, a wheaten food is contained in one of the compartments, a powdery soup-containing pouch is contained in the other of the compartments, and a lid is appended to the upper end opening of the cupped container.

5. A wheaten food with powdery soup in a cupped container, in which a bread and a powdery soup-containing pouch are contained in the cupped container and a lid is pasted to the upper end opening of the cupped container.

6. A wheaten food with powdery soup in a cupped container according to claim 1, wherein the wheaten food is bread.

7. A wheaten food with powdery soup in a cupped container, in which a dehydrated or semi-dehydrated bread is prepared such that the water content therein is somewhat reduced.

8. A method of eating a wheaten food with powdery soup in a cupped container according to claim 1, which comprises opening the outer lid and taking out the inner container, seal opening the powdery soup-containing pouch, entering a powdery soup to the inside of the outer container, pouring a required amount of hot water to dissolve the powdery soup, capping immediately thereafter the inner container to the opening end of the outer container such that an inner lid is situated below, leaving them for a predetermined period of time thereby causing steams evolved upon dissolving the powdery soup to flow into the inner container by way of the plurality of small apertures thereby moistening and warming the wheaten food, then opening an inner lid of the inner container to take out the wheaten food, and eating the same while soaking the same in the powdery soup in the outer container.

9. A method of eating a wheaten food with powdery soup in a cupped container according to claim 2, which comprises peeling a portion of the lid, seal opening the powdery soup-containing pouch thereby entering the powdery soup into the other of the compartments, pouring a required amount of hot water to dissolve the powdery soup, capping the lid immediately thereafter to seal the upper end opening of the cupped container, causing the steams evolved upon dissolving the powdery soup to enter them from the space above the partitioning wall or from the upper end of the partitioning wall into one of the compartments thereby moistening and warming the wheaten food, then entirely peeling the lid of the cupped container and taking out the wheaten food, and eating the food while soaking the same in the powdery soup in the other of the compartments.

10. A wheaten food with powdery soup in a cupped container according to claim 2, wherein the wheaten food is bread.

11. A wheaten food with powdery soup in a cupped container according to claim 3, wherein the wheaten food is bread.

12. A wheaten food with powdery soup in a cupped container according to claim 4, wherein the wheaten food is bread.

13. A method of eating a wheaten food with powdery soup in a cupped container according to claim 3, which comprises peeling a portion of the lid, seal opening the powdery soup-containing pouch thereby entering the powdery soup into the other of the compartments, pouring a required amount of hot water to dissolve the powdery soup, capping the lid immediately thereafter to seal the upper end opening of the cupped container, causing the steams evolved upon dissolving the powdery soup to enter them from the space above the partitioning wall or from the upper end of the partitioning wall into one of the compartments thereby moistening and warming the wheaten food, then entirely peeling the lid of the cupped container and taking out the wheaten food, and eating the food while soaking the same in the powdery soup in the other of the compartments.

14. A method of eating a wheaten food with powdery soup in a cupped container according to claim 4, which comprises peeling a portion of the lid, seal opening the powdery soup-containing pouch thereby entering the powdery soup into the other of the compartments, pouring a required amount of hot water to dissolve the powdery soup, capping the lid immediately thereafter to seal the upper end opening of the cupped container, causing the steams evolved upon dissolving the powdery soup to enter them from the space above the partitioning wall or from the upper end of the partitioning wall into one of the compartments thereby moistening and warming the wheaten food, then entirely peeling the lid of the cupped container and taking out the wheaten food, and eating the food while soaking the same in the powdery soup in the other of the compartments.
